(19) United States
(12) Patent Application Publication
(10) Pub. No.: US 2013/0173495 A1
(43) Pub. Date: Jul. 4, 2013

(54) SYSTEM AND METHOD FOR INTEGRATING, EVALUATING, AND MANAGING FINANCIAL DATA

(71) Applicants: Joseph Davidsohn, Surfside, FL (US); George Davidsohn, Surfside, FL (US)

(72) Inventors: Joseph Davidsohn, Surfside, FL (US); George Davidsohn, Surfside, FL (US)

(73) Assignee: Davidsohn Global Technologies, Inc., New York, NY (US)

(21) Appl. No.: 13/589,770

(22) Filed: Aug. 20, 2012

Related U.S. Application Data
(60) Provisional application No. 61/525,311, filed on Aug. 19, 2011.

(51) Int. Cl. G06Q 40/06

(52) U.S. Cl. CPC G06Q 40/06
USPC 705/36 R; 705/37

(57) ABSTRACT

Asset evaluation systems and methods are presented in which a financial firm's reported holdings may be received and evaluated based on external data sources. The asset evaluation systems and methods may then make a determination as to the risk involved in the financial firm's holdings portfolio and report risky or fraudulent activity.

### CROSS REFERENCE TO RELATED APPLICATION

This application claims the benefit of U.S. Provisional Patent Application Ser. No. 61,525,311, filed Aug. 19, 2011, which is incorporated herein by reference in its entirety as if fully set forth below.

### BACKGROUND OF THE INVENTION

The financial crisis of 2007-2008 was a web of failure in which hundreds of interdependent institutions had operated without oversight, transparency, or restraint, and threatened to collapse together. The present invention provides financial market data gathering and evaluation mechanisms for identifying vulnerabilities and arming regulators with the data they need to improve market discipline and stability.

### BRIEF LISTING OF THE FIGURES

FIG. 1 is an exemplary risk dashboard interface according to aspects of the present invention.

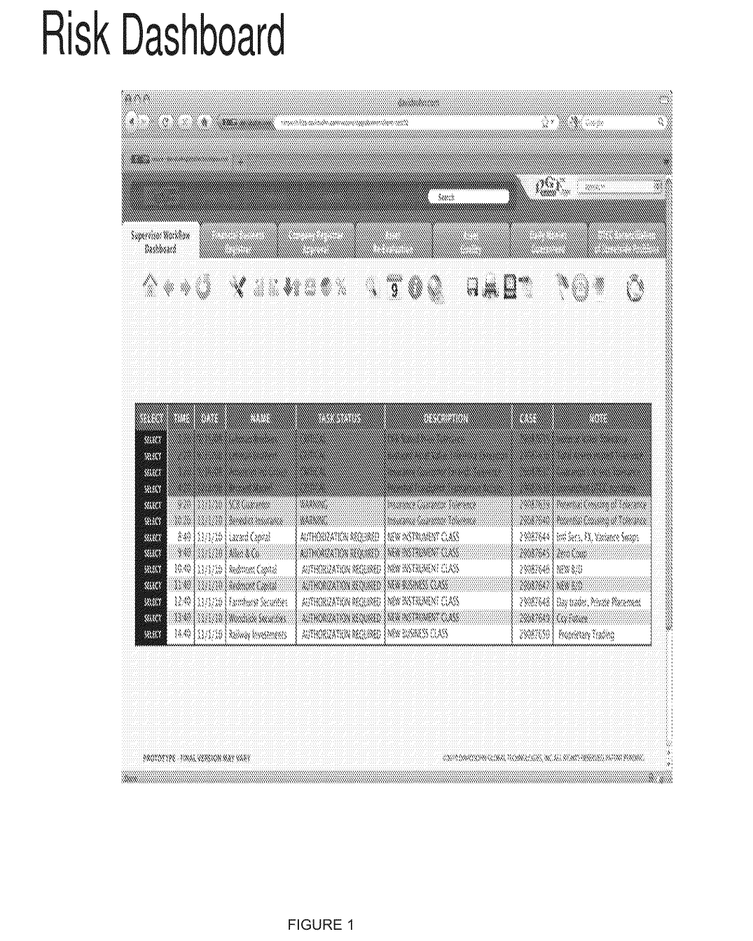

FIG. 2 is an exemplary business registration and baseline measurement interface according to aspects of the present invention.

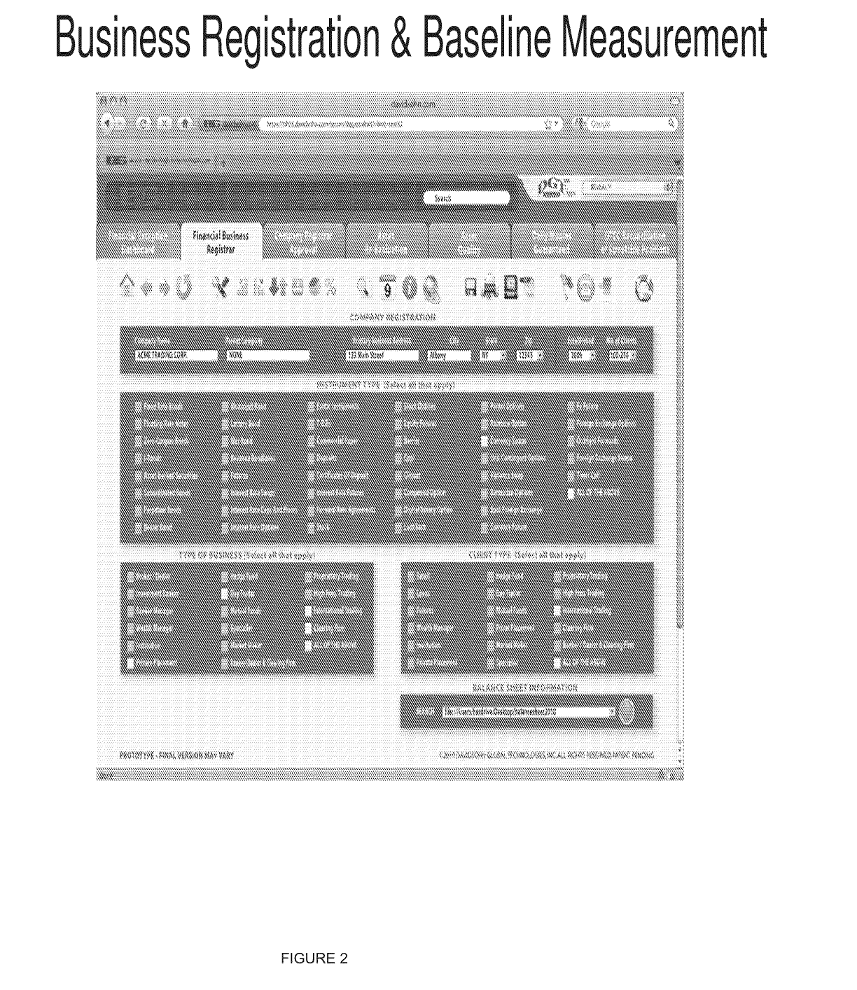

FIG. 3 is an exemplary instrument and product pie duct catalogue interface according to aspects of the present invention.

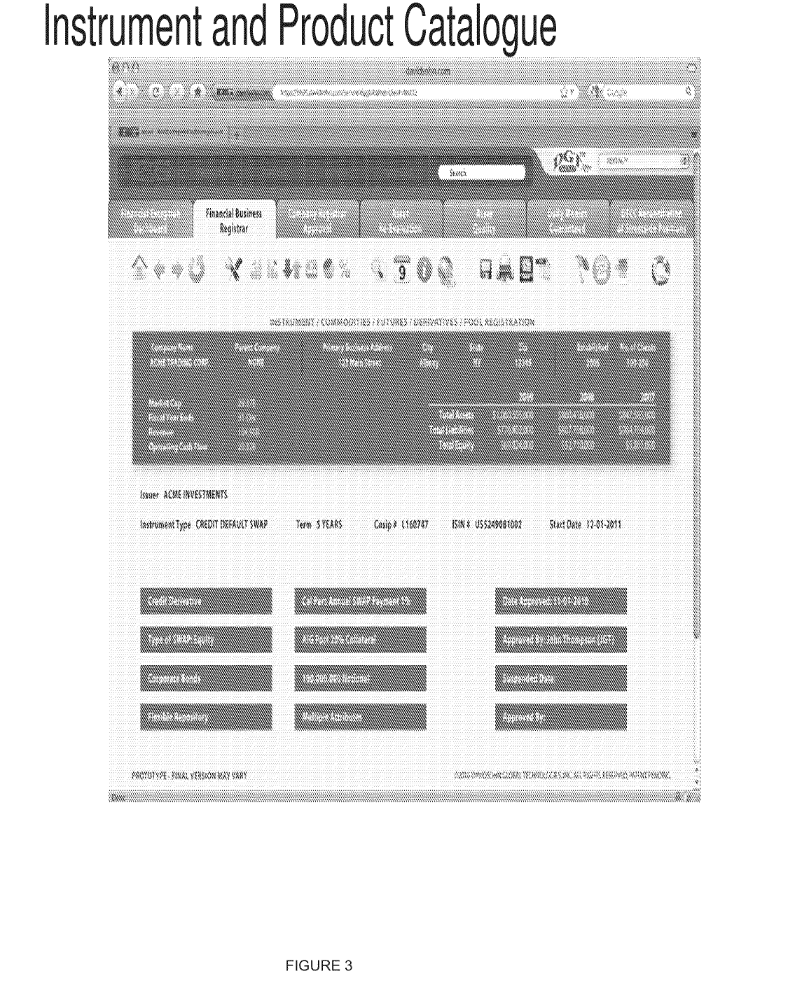

FIG. 4 is an exemplary asset quality evaluation interface according to aspects of the present invention.

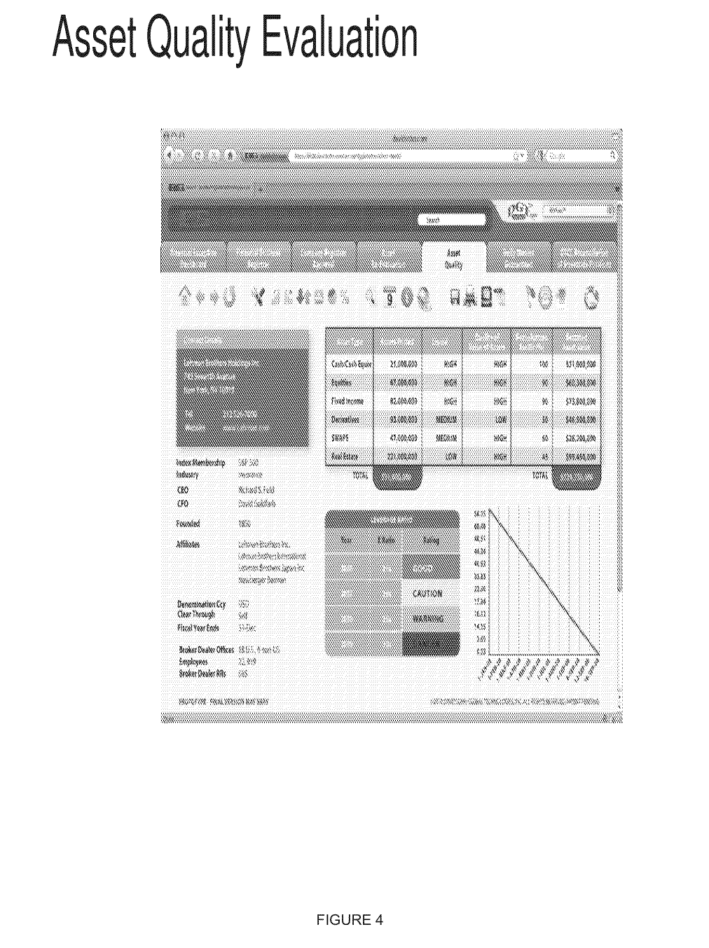

FIG. 5 is an additional exemplary risk dashboard interface according to as aspects of the present invention.

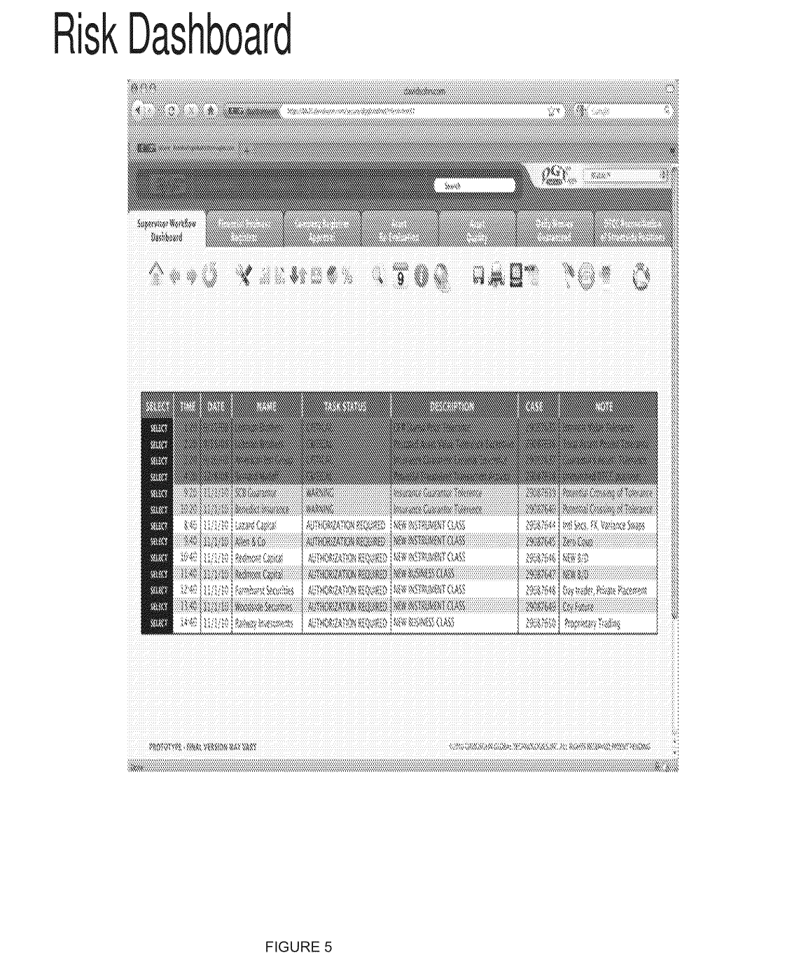

FIG. 6 is an exemplary asset liability and review interface according to aspects of the present invention.

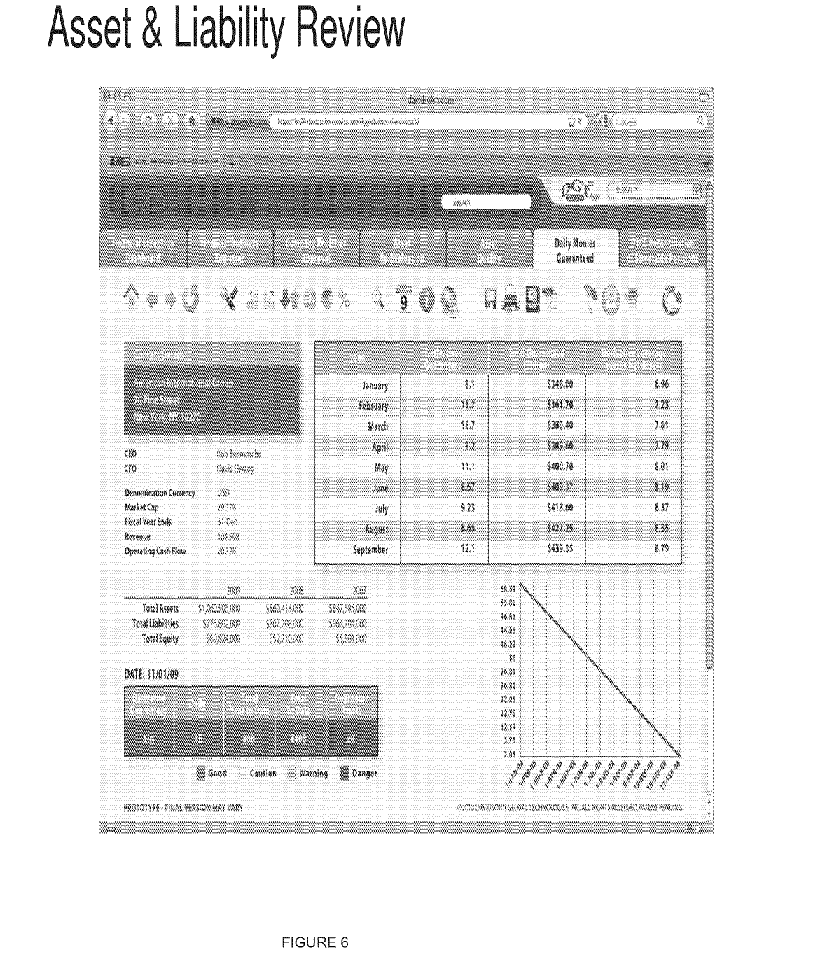

FIG. 7 is an exemplary balance sheet reconciliation interface according to aspects of the present invention.

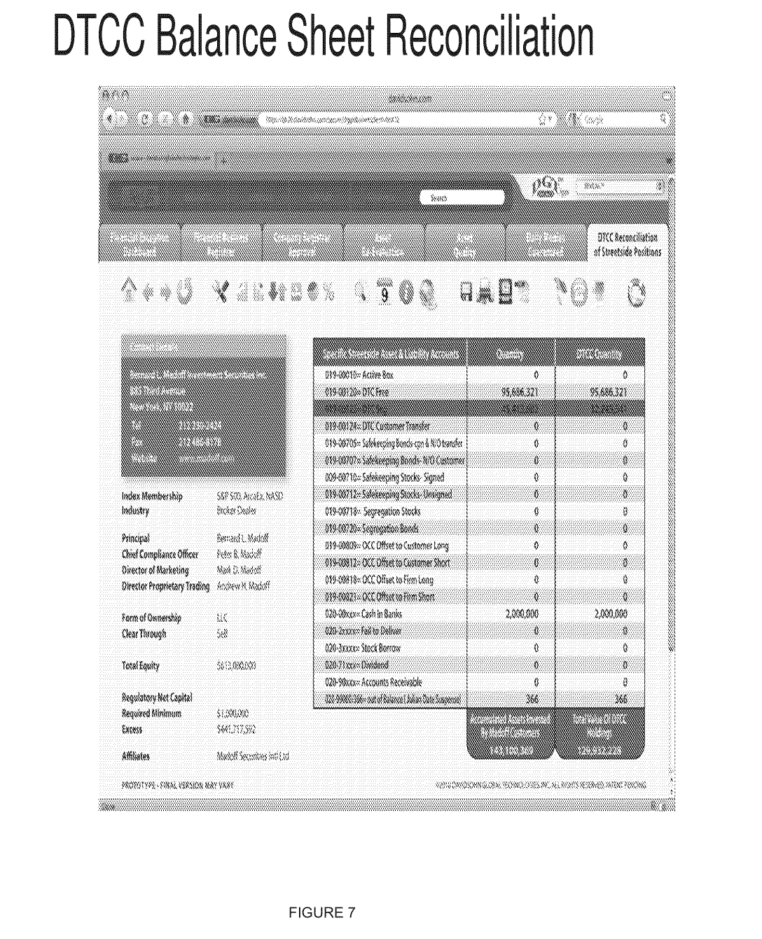

### DESCRIPTION OF THE INVENTION

The present invention comprises a method implemented on a program controlled data processor and a system for processing financial data to assess risk assumptions and institutional health. The following description is meant to be illustrative and not limiting.

The present invention allows for cataloging existing regulatory data, improved financial market data gathering (including utilization of existing data to avoid duplicative requests), identification of vulnerabilities in the system, and assessment of institutional risk levels and health. The present technology is operable using existing communication protocols that the Financial Industry utilizes today, thus allowing for seamless transition and collaboration with current banking and trading platforms.

The present invention includes a central registrar for obtaining data from business and financial institutions (including SRO's, hedge funds, private equity firms and all so-called “Big Money” market players that are yet unregistered), as well as a reference database of all financial instruments and products as required by Dodd-Frank. By certifying businesses and approving them for trade the present invention will establish operational baselines for every actor. Additionally, by evaluating newly created securities and trading instruments for mandated approval prior to use in trading, regulators will be provided with a standardized system for identifying all assets according to category and class.

Risk, capital, and fraud are all monitored by the system. With respect to risk monitoring, the following example is provided. By 2007 Lehman Brothers, through the bank's acquisition of subprime mortgage backed securities, had leveraged itself 30:1—up from 21:1 in 2003. When homeowners began to default and lenders around the country filed for bankruptcy, Lehman was left to collapse under the weight of its toxic assets. Periodic review of institutional balance sheets on even a monthly basis would have revealed Lehman's over leveraged position as a result of short term financing with illiquid assets. It would have also revealed a high concentration of risk in one area. Had regulators evaluated the quality of Lehman's assets in light of existing models of systemic risk during the months before the collapse, they would have had the opportunity to intervene and force Lehman to begin deleveraging at a ‘critical juncture’, thus averting disaster.

The present system's Asset Quality Evaluation models would present regulators with a view of institutional holdings, liquidity and risk as determined by the mandatory submission and review of balance sheets. By comparing the assets reported with those already registered and rated in the central catalogue, regulators could ascertain the true value of an institution's holdings as well as its overall health.

In one embodiment, the present invention includes a “Risk Dashboard” that is able to present regulators with an integrated view of institutional investment activity over-time, including risk concentrations and over leveraging alerts. The Risk Dashboard can raise action items in real-time, and where necessary, escalates the item throughout the organization. Actions may have a defined lifecycle and choreography with a full audit trail.

Another important area monitored by the system is capital. With respect to capital, the following example is provided. By underwriting the derivatives sold against subprime mortgage backed securities and insuring assets for more than the firm was worth, AIG assumed untenable levels of counter party risk—ultimately becoming responsible for billions in payouts once the securities (which they had guaranteed far in excess of their capital) went into default. Had regulators been able to review AIG's balance sheet over the course of time and measure the insurer's liabilities against its assets, they would have seen an accumulation of CDS's—instruments that would now be registered in the central catalogue—as compared to insufficient capital reserves. Regulators could have then stopped AIG from selling insurance against assets which they did not own as well as from continuing to follow a non-viable model that extended AIG's guarantees beyond the institution's worth. The present invention's insurance underwriting leverage dashboard, would present regulators with a proactive overview showing changes in derivative guarantees vs. net assets. In one embodiment, the system alerts the user when a predefined threshold is met, such as a certain ratio of derivative guarantees to net assets or a percentage change in the ratio.

Fraud is an additional area that may be monitored by the present system. With no system of checks and balances in place, Bernard Madoff was able to engage in a decades-long Ponzi Scheme. In a preferred embodiment, a national system is created in which every firm submits their positions nightly and then each position is reconciled and checked against the Depository Trust and Clearing Corporation's (DTCC) holdings, allowing for a dual view of both share-side and street-side to be ascertained. By subjecting all market actors to daily checks, regulators would have the ability to uncover fraudulent activity at the onset, ensuring that what firms are booking and claiming to hold matches up against the industry owned depository's records. A daily, mandated comparison of ‘street-side’ reporting with DTCC holdings would immediately reveal fraudulent trading activity and false reporting on the part of any registered businesses.

### Optional Features and Embodiments

### Global Meltdown

The financial crisis of 2007-2008 was a web of failure in which hundreds of interdependent institutions had operated without oversight, transparency, or restraint, and threatened to collapse together. However, with the right financial market data gathering mechanisms in place, the abuses of large-scale actors could have been prevented and the health of the industry as a whole preserved. We posses the ability to provide the OFR with existing technologies to identify vulnerabilities and arm regulators with the data they need to improve market discipline and stability.

### Solutions

COMPREHENSIVE INSTRUMENT AND PRODUCT CATALOGUE: Existing solutions can provide the structure for creating and maintaining a central registrar for all businesses as well as a reference database of all financial instruments and products as required by Dodd-Frank. By certifying businesses and approving them for trade we will establish operational baselines for every actor. Additionally, by evaluating newly created securities and trading instruments for mandated approval prior to use in trading, regulators will be provided with a standardized system for identifying all assets according to category and class.

BALANCE SHEET OVERSIGHT: Periodic review of institutional balance sheets on even a monthly basis would have revealed Lehman's over leveraged position as a result of short term financing with illiquid assets. It would have also revealed a high concentration of risk in one area.

Had regulators evaluated the quality of Lehman's assets in light of existing models of systemic risk during the months before the collapse, they would have had the opportunity to intervene and force Lehman to begin deleveraging at a ‘critical juncture’, thus averting disaster.

CAPITAL VERIFICATION: Had regulators been able to review AIG's balance sheet over the course of time and measure the insurer's liabilities against its assets, they would have seen an accumulation of CDS's—instruments that would now be registered in the central catalogue—as compared to insufficient capital reserves.

Regulators could have then stopped AIG from selling insurance against assets which they did not own as well as from continuing to follow a non-viable model that extended AIG's guarantees beyond the institution's worth.

RECONCILIATION: By creating a national system in which every firm submits their positions nightly and then each position is reconciled and checked against DTCC's holdings, a dual view of both share-side and street-side could be ascertained.

By subjecting all market actors to daily checks, regulators would have the ability to uncover fraudulent activity at the onset, ensuring that what firms are booking and claiming to hold matches up against the industry owned depository's records.

### Capabilities of Various Embodiments

Existing technologies that communicate in the same language and messaging protocols the Financial Industry uses today.
Seamless transition and collaboration with current banking and trading platforms.
Establish improved financial market data gathering.
Implement standards for financial reporting.
Catalogue existing regulatory data.
Identify vulnerabilities in the system.
Assess institutional risk levels and health.
Utilize existing data to avoid duplicative requests.

The invention described above is operational with general purpose or special purpose computing system environments or configurations. Examples of well known computing systems, environments, and/or configurations that may be suitable for use with the invention include, but are not limited to: personal computers, server computers, hand-held or laptop devices, tablet devices, multiprocessor systems, microprocessor-based systems, set top boxes, programmable consumer electronics, network PCs, minicomputers, mainframe computers, distributed computing environments that include any of the above systems or devices, and the like.

Components of the inventive computer system may include, but are not limited to, a processing unit, a system memory, and a system bus that couples various system components including the system memory to the processing unit. The system bus may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer system typically includes a variety of non-transitory computer-readable media. Computer-readable media can be any available media that can be accessed by the computer and includes both volatile and nonvolatile media, and removable and non-removable media. By way of example, and not limitation, computer-readable media may comprise computer storage media and communication media. Computer storage media may store information such as computer-readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by the computer. Communication media typically embodies computer-readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer-readable media.

The computer system may operate in a networked environment using logical connections to one or more remote computers. The remote computer may be a personal computer, a server, a router, a network PC, a peer device or other common network node, and typically includes many or all of the elements described above relative to the computer. The logical connections depicted in include one or more local area networks (LAN) and one or more wide area networks (WAN), but may also include other networks. Such networking environments are commonplace in offices, enterprise-wide computer networks, intranets and the Internet.

For ease of exposition, not every step or element of the present invention is described herein as part of software or computer system, but those skilled in the art will recognize that each step or element may have a corresponding computer system or software component. Such computer systems and/or software components are therefore enabled by describing their corresponding steps or elements (that is, their functionality), and are within the scope of the present invention. In addition, various steps and/or elements of the present invention may be stored in a non-transitory storage medium, and selectively executed by a processor.

The foregoing components of the present invention described as making up the various elements of the invention are intended to be illustrative and not restrictive. Many suitable components that would perform the same or similar functions as the components described are intended to be embraced within the scope of the invention. Such other components can include, for example, components developed after the development of the present invention.

What is claimed is:

1. A computer-implemented method, comprising:
receiving, from each of a plurality of financial firms, an indication of financial positions held in the market;
reconciling the indications of the plurality of financial firms against depository records;
determining fraudulent trading activity based on said reconciliation; and
reporting the determined fraudulent activity.

2. The computer-implemented method of claim 1, wherein reporting the determined fraudulent activity is performed via a risk dashboard.

3. A system for evaluating financial health, comprising:
an asset quality evaluation module for evaluating a set of reported assets belonging to a firm;
wherein the asset quality module receives the set of reported assets, compares the set of reported assets to a separate set of rated assets, and determines an health rating of the set of reported assets.

4. The system for evaluating financial health of claim 3, wherein the health rating is reported via a risk dashboard.
